(19) United States
(12) Patent Application Publication
(10) Pub. No.: US 2003/0014331 A1
(43) Pub. Date: Jan. 16, 2003

(54) Affiliate marketing search facility for ranking merchants and recording referral commissions to affiliate sites based upon users' on-line activity

(76) Inventor: Erik Neal Simons, Calgary (CA)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/849,988

(22) Filed: May 8, 2001

(51) Int. Cl. G06F 17/60; G06F 7/00; G06F 17/30

(52) U.S. Cl. 705/27; 707/7; 705/26

(57) ABSTRACT

Providing a search facility to a consumer that may be accessed by the consumer through a participating affiliate marketing web site. The search facility conducts searches of databases that include both merchants that pay a cost-per-action commission to the search facility based upon actual sales to consumers introduced to the merchant by the search facility, and merchants that pay a cost-per-click commission based upon the number of accesses of the merchant's site from the search facility. The search facility ranks the merchants for display in search results based upon the commissions paid and possibly other factors. The search facility also tracks sales-based commissions and can pay other types of commissions based upon or in proportion to the sales based commissions.

### FIELD OF THE INVENTION

This invention relates to a computer method and system for providing a facility for users to search for merchants using a communications network and, more particularly, to a method and system for providing a facility that provides ranked search results.

### BACKGROUND OF THE INVENTION

A significant percentage of current worldwide e-commerce revenues are attributable to affiliate marketing. An affiliate includes an owner of a web site. Affiliate marketing involves e-commerce merchants paying affiliates to direct Internet surfers, or network “traffic”, to the merchants' web sites. Affiliates create software links, such as hyperlinks, between affiliate and merchant web sites using a variety of techniques to encourage traffic to visit merchant sites or “click-through” to the site. Merchants are willing to pay the affiliates for traffic, either when they click-through to a site (referred to as a “cost-per-click” or “CPC” basis of payment) or when click-throughs result in sales, web site registrations or other actions valuable to the merchants (referred to as a “cost-per-action” or “CPA” basis of payment). Both CPA and CPC payment methods are used in affiliate marketing.

Affiliate marketing service providers provide affiliate marketing outsourcing solutions for on-line merchants. Outsourcing the affiliate marketing function is a cost effective way for merchants to implement affiliate marketing programs. Internet affiliate marketing programs for merchants use billboard style banner advertisements and cost-per-click and cost-per-action commissions. With billboard style banner ads merchants pay for the right to place an on-line advertisement on high-traffic affiliate sites, and fees for this form of advertising are typically paid on the basis of the number of times a banner is downloaded by a computer server when a surfer accesses the web page on which it appears. Cost-per-click commissions involve paying only for traffic that “clicked through” on a banner to the merchant site, with flat rate compensation being paid on a cost-per-click basis.

However, “click throughs” often do not result in sales, and therefore the CPC commissions do not necessarily reward affiliates based upon performance. Merchants cannot afford to pay high CPC rates due to the fact that fraudulent click throughs by surfers who have no intention of purchasing goods or services are endemic to the CPC system. Affiliates who generate qualified sales traffic on behalf of merchants who, as a result of fraud, must pay lower CPC rates do not, therefore, get paid for the full value of the traffic they offer. Where merchants use banners and pay affiliates on a CPA basis, this method is not efficient because fewer and fewer surfers click through on banners today, and as such neither the merchant nor the affiliate will be able to generate substantial sales this way. Accordingly, a need exists to provide a method and system which maximizes incentives for merchants and affiliates through maximizing both merchant sales and affiliate commissions.

### SUMMARY OF THE INVENTION

A method and system consistent with the present invention provides a search facility to a customer that may be accessed by the consumer through a participating web site such as an affiliate web site. The search facility searches databases possibly including both merchants that pay affiliates referral commissions based upon actual sales to consumers introduced to the merchant by the search facility (a CPA basis) and merchants that pay the search facility a CPC-based flat rate commission based upon a consumer accessing or “clicking through” to merchant's site from the search facility.

The search facility typically ranks merchants that pay commissions on a CPA-basis higher, for example, in the search results than merchants that pay commissions based upon a CPC-basis. The search facility tracks sales-based commissions earned by the affiliate web site that referred the consumer who made the purchase by transferring the consumer's network connection to the merchant. The facility pays a share of each sales commission received by it to the affiliate web site. Fees collected from merchants that pay commissions based upon CPC facility can be allocated to the affiliate web sites that carry the search facility in proportion, for example, to total CPA-based commissions earned by such affiliate.

### BRIEF DESCRIPTION OF THE DRAWINGS

The accompanying drawings are incorporated in and constitute a part of this specification and, together with the description, explain the advantages and principles of the invention. In the drawings,

FIG. 1 illustrates a first methodology using an affiliate marketing site;

FIG. 2 illustrates a second methodology using an affiliate marketing site;

FIG. 3 illustrates a third methodology using an affiliate marketing site;

FIG. 4 illustrates a fourth methodology using an affiliate marketing site;

FIG. 5 is a diagram of an exemplary system for ranking merchants and providing commissions for referrals using the methodologies illustrated in FIGS. 1-4;

FIG. 6 is a diagram of an exemplary server for use with the system;

FIG. 7 is a flow chart of a system server processing;

FIG. 8 is a flow chart of an agent program method;

FIG. 9 is a flow chart of a retrieve data method;

FIG. 10 is a flow chart of an update database method;

FIG. 11 is a flow chart of an affiliate site method;

FIG. 12 is a diagram of an exemplary affiliate network site screen;

FIG. 13 is exemplary diagram of an exemplary search results screen; and

FIG. 14 is a diagram of exemplary merchant site screen.

### DETAILED DESCRIPTION

### Search Facility Methodologies

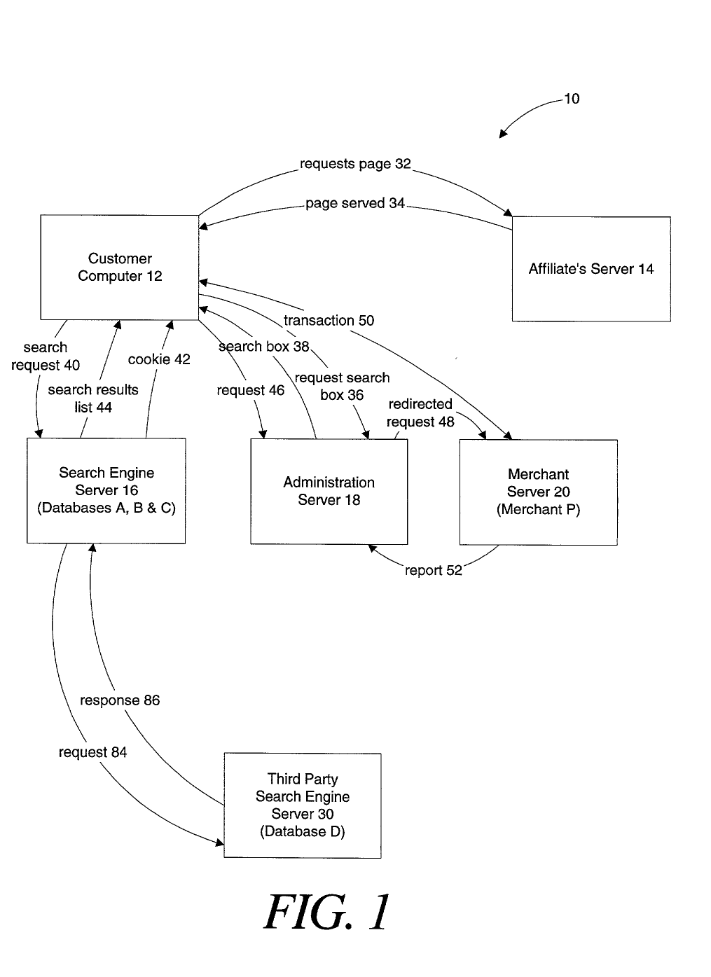

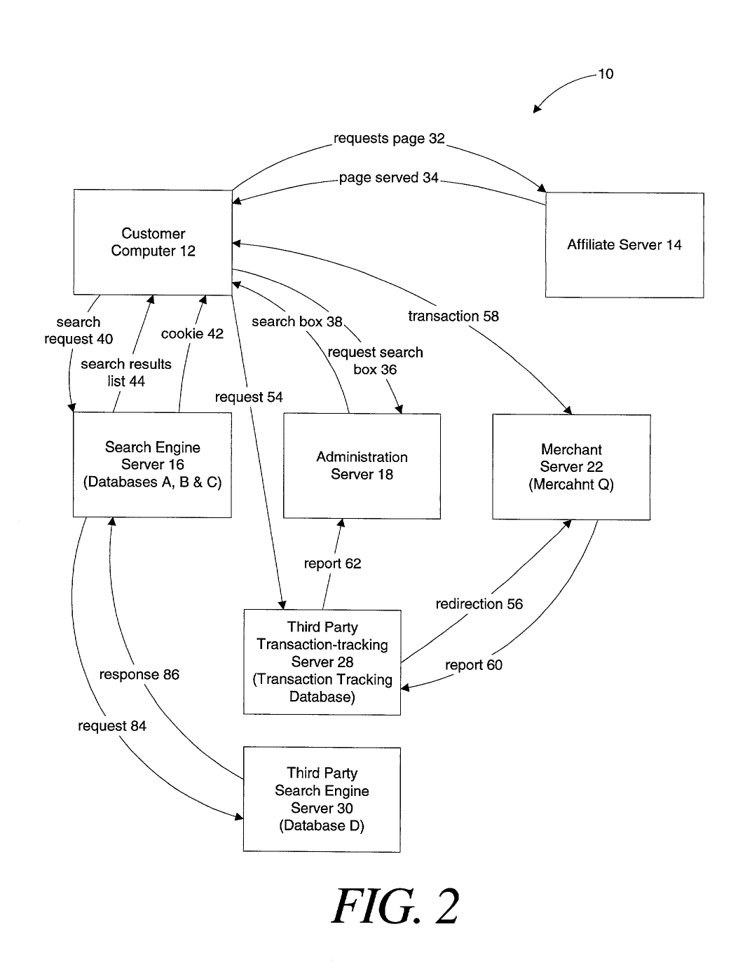

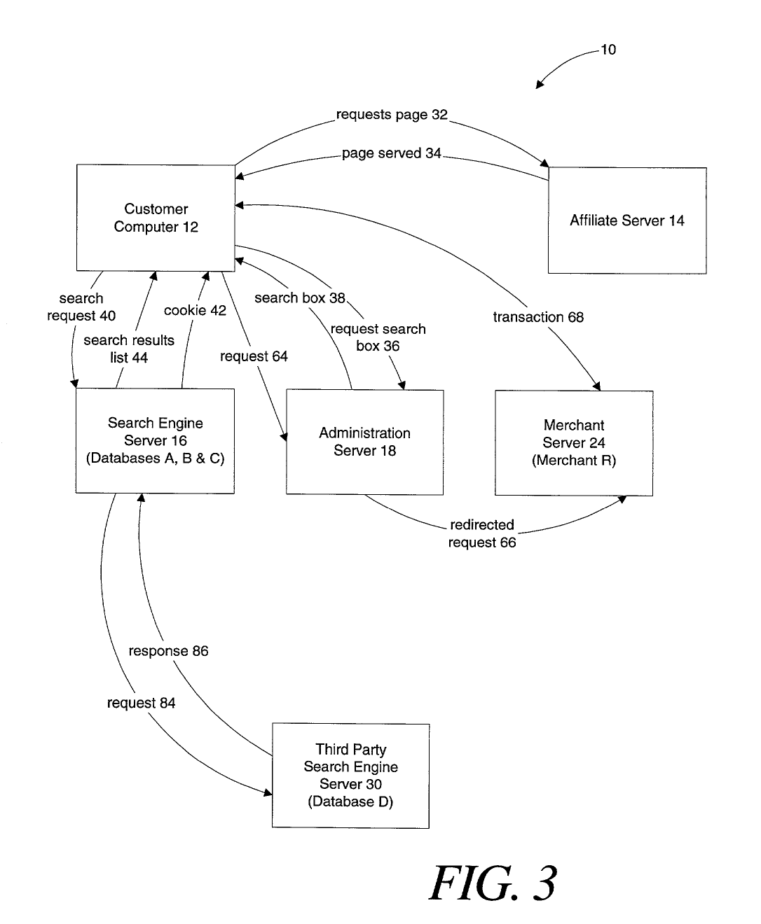

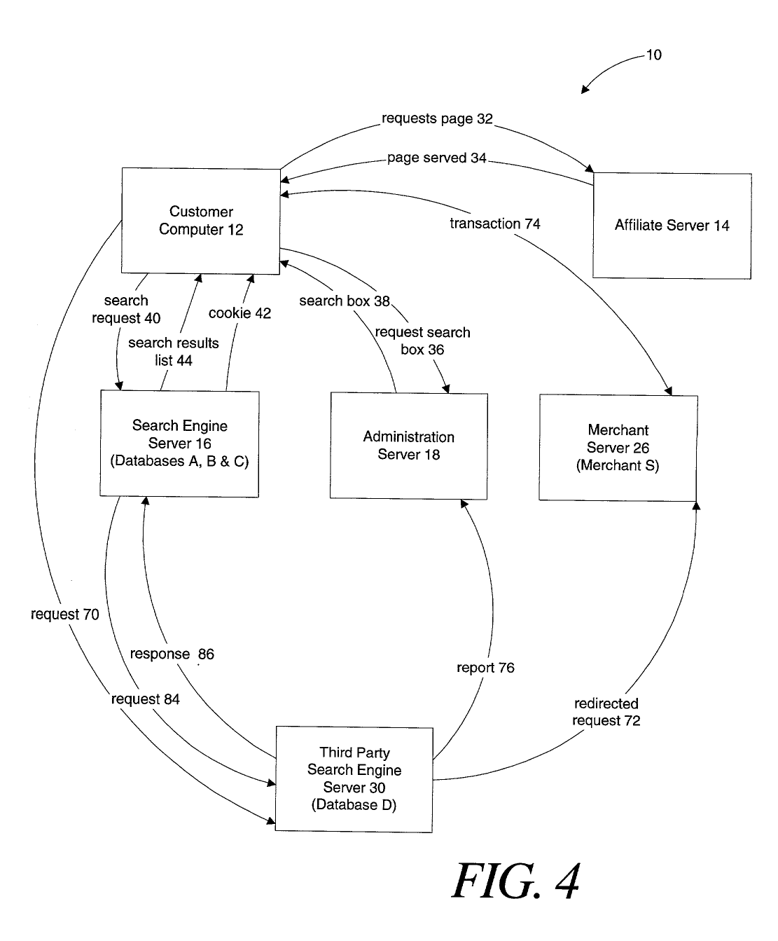

The overall operation of an exemplary search facility for providing a user or consumer with the opportunity to search for merchants using a communications network such as the Internet is shown in FIGS. 1-4. The exemplary system is indicated generally by reference numeral 10 in FIGS. 1-4. The exemplary system 10 includes: a consumer computer 12; an affiliate server 14; a search engine server 16; an administration server 18, four merchant servers 20, 22, 24, and 26; a third party transaction-tracking server 28; and third party search engine server 30. To facilitate understanding of the following discussion, only one of the merchant servers 20, 22, 24, 26 is shown in each of FIGS. 1-4, respectively. The consumer computer 12 and all of the servers are connected to a communications network such as the Internet (not shown explicitly). For the purposes of this example, the communication protocol uses HyperText Transport Protocol (HTTP); any type of communication protocols could be used.

While FIGS. 1-4 show several distinct blocks, each block representing a separate computer, those skilled in the art will recognize that each block may represent a discrete process or processes running on the same computer as one or more of the other blocks. For example, search engine server 16 and administration server 18 may both run on a single computer.

The overall sequence of the data flow and methodologies among the computers shown in FIGS. 1-4 is indicated by directed line segments connecting the various blocks of FIG. 1-4. As explained below, the lines represent a sequence of actions, requests, and responses that would occur in a typical situation in which a consumer operating the consumer computer 12 would use the exemplary system 10 to conduct a search for merchants that provide goods or services of interest to the consumer.

A consumer causes the consumer computer 12 to send an HTTP request 32 for a page stored on the affiliate server 14. The request may be sent using a conventional web browser program. For example, the consumer may have been “browsing” the Internet using conventional browsing software (e.g., the Internet Explorer program from Microsoft Corp. or the Netscape Navigator program from Netscape Communications, Inc.) and was presented with a hyperlink to a page described by data stored on affiliate server 14. The hyperlink contains the Uniform Resource Locator (URL) of affiliate server 14.

The consumer selects or “clicks” the hyperlink, causing consumer computer 12 to send the request 32, which would contain the URL of the affiliate server 14. The URL of affiliate server 14 is translated into a numeric Internet address by a name server computer and the request 32 eventually arrives at affiliate server 14. The various data transmissions over the network can occur using, for example, Transmission Control Protocol/Internet Protocol (TCP/IP). For these methodologies, special software is not necessarily required on consumer computer 12, other than conventional browser software capable of displaying pages in HyperText Markup Language (HTML). For example, request 32 might be: http://www.affiliatesite.com, where www.affiliate.com is the URL of affiliate server 14.

Affiliate server 14 responds to request 32 by transmitting a response 34 to consumer computer 12. The response 34 may include a page described in HTML that includes a form to be filled in with a search term and the URL of a graphic of a search box. An exemplary search screen or form is described below. The LRL may contain a hyperlink that “points to” the administration server 18. The form may also include a “search” button that will cause any data filled in on the form to be sent to the search engine server 16. Hence, the form also includes the URL of the search engine server 16.

The consumer computer 12 receives response 34. In the course of displaying the page described in the HTML contained in the response 34, the browser software on consumer computer 12 encounters the URL of the graphic and sends a request 36 for that graphic to administration server 18. The graphic could be stored, for example, on affiliate server 14, search engine server 16, or elsewhere. Alternatively, no graphic is necessary. The operator of administration server 18 may desire to retain control over the appearance of the graphic used in the search form. However, the actual location of the data describing the graphic does not necessarily have to be administration server 18. If a graphic is used for the search box and is stored on the administration server 18, the following request 36 maybe sent to an administration server 18, the URL of which is www.admoneylink.com, to retrieve the graphic:

http://www.admoneylink.com/banners/standard/blue/java.htm.

Administration server 18 responds to request 36 with a transmission 38 to the consumer computer 12, including in the transmission 38 HTML data representing the graphic of the search box. Consumer computer 12 receives transmission 38 and displays on a display device the graphic of the search box together with the page received from the affiliate server 14.

The consumer may then fill in the form that is displayed on consumer computer 12 with a search term or terms and select (“click on”) the “search” button. Consumer computer 12, in response to the consumer selecting the “search” button, sends a request 40 to search engine server 16. The request 40 includes the search term or terms filled in by the consumer and a key uniquely identifying the operator of the affiliate server 14. An example of a key uniquely identifying an operator of a server is referred to as the “ID” or “webmaster ID” of that operator. For example, in the following sample request 40, the search term is “cars” and the ID of the operator of affiliate server 14 is “1234”:

http://www.erossa.com/cgi-bin/search/hyperseek.cgi?Terms=cars&memID2=1234.

Optionally, search engine server 16 may respond to request 40 by sending to consumer computer 12 a string of data, referred to as a “cookie” 42, containing the ID of the operator of affiliate server 14. The cookie 42 may be used if the consumer's computer 12 requests a search from the search engine server 16 in a later session or if the consumer computer 12 requests a page from a merchant server that has appropriate tracking software installed. In both cases, the operator of affiliate server 14 is credited appropriately for having referred the consumer to an appropriate merchant server.

The search engine server 16, in response to request 40, searches four databases, for example, referred to below as databases A, B, C, and D, for merchants that satisfy the search criteria provided by the consumer in request 40. The search engine server 16 can use, for example, Hyperseek™ software from iWeb, Inc. that has been configured to search databases A, B, C, and D, and prepare HTML pages describing the search results. An exemplary search results page is described below. For each merchant, a link is provided in the search results pages. The content of the link depends upon the database in which the merchant was located. FIGS. 1-4 show only one affiliate server 14 and four merchant servers 20, 22, 24, and 26 for illustrative purposes only. The system described in this specification may typically handle many affiliate servers and many merchant servers.

Database A contains a list of merchants that have installed tracking software on the servers operated for them. The tracking software reports to the administration server 18 information regarding sales by the merchants to the consumer. Of the four merchants P, Q, R, and S, only merchant P is listed in database A in this example. The merchants listed in database A have agreed to pay to the operator of the administration server 18 a commission based on the sales to consumers directed to the servers operated for the merchants by the affiliate server 14.

Database B is a database of merchants that have agreements with a third party that operates as third party transaction-tracking server 28 under which tracking software has been installed on the merchant servers operated for the merchants. The software provides tracking information to third party transaction-tracking server 28, and that information in turn is provided to administration server 18. Of the four merchants P, Q, R, and S, only merchant Q is listed in database B in this example. An example of third party transaction-tracking server is a product maintained by Commission Junction, Inc. Database B is maintained by search engine server 16 and contains links that point to third parties' servers so that they can record and track sales information relating to clicks to those merchants.

Database C contains a list of merchants that have agreed to pay the operator of the administration server 18 for each HTTP request received from a consumer through the administration server 18. Each such merchant has, for example, deposited funds from which an agreed-to sum is deducted for each request forwarded to the merchant through the administration server 18. Of the four merchants P, Q, R, and S, only merchant R is listed in database C in this example. The software to manage this database may be obtained from, for example, iWeb, Inc. and is an add-on module used with the Hyperseek™ software and runs on the administration server 18.

Database D is maintained by a third party search engine server 30, such as goto.com. In response to a search request 84 from the search engine server 16 database D provides a response 86 including a list of merchants that will pay for each request that they (the merchants) receive from the third party search engine server 30. Of the four merchants P, Q, R, and S, merchant S is listed in database D in this example.

After a search of databases A, B, C, and D has been conducted by the search engine server 16, it responds to customer computer 12 by transmitting search results 44 to it. The search results 44 are preferably provided as HTML data describing a page or pages that include hypertext links, possibly embedded, that lead the consumer to merchant servers operated for the merchants found in the search. In each case, the hyperlink points to an intermediary server (administration server 18, third party transaction-tracking server 28, or third party search engine server 30) that will in turn redirect the consumer to the appropriate merchant server. The details of this process are described below. The search results 44 may also display other information about a merchant found in the search, such as the merchant's name, address, telephone number, goods or services provided, and may also include other keys, which are described below, that are used by the intermediary server.

The consumer computer 12 displays the search results 44 received from the search engine server 16. In this example, the hyperlinks associated with four merchants P, Q, R, and S are displayed. For illustrative purposes, assume that merchant P for whom merchant server 20 is operated was found in a search of database A, merchant Q for whom merchant server 22 is operated is found in the search of database B, merchant R for whom merchant server 24 is operated is found in the search of database C, and merchant S for whom merchant server 26 is operated is found in the search of database D. Hence, the search results 44 sent by search engine 16 list only merchants P. Q, R, and S in this example. In a full scale application of the system there can be thousands of merchants, and search results 44 may contain a larger number of merchants. For that reason or other reasons, some method for ranking the displayed search results is highly desirable.

In the balance of this example, it is assumed that the consumer selects first the hyperlink associated with merchant P on a page of search results displayed by the consumer computer 12, proceeds to make a purchase from merchant P, returns to the displayed search results, and then in turn selects the hyperlinks associated with the other three merchants Q, R, S and in each case makes a purchase from each. This exemplary sequence of actions illustrates the manner in which the search results 44 are handled for each type of merchant contemplated by the exemplary system 10.

The consumer first clicks the hyperlink associated with merchant P on the search results page. The hyperlink associated with merchant P includes the URL of the administration server 18. When the hyperlink is selected, a request 46 is sent to the administration server 18. The hyperlink also contains, for example, the ID of merchant P, the ID of the operator of affiliate server 14, and may contain the search term that the customer used in the search request 40. The following is an example of a request 46 in which the URL of the administration server 18 is www.admoneylink.com, the ID of operator of the affiliate server 14 is “1234”, the ID of merchant P is “2435353,” and the search term was “cars”:

http://www.admoneylink.com/cgi-bin/log.cgi?webid=1234&merID=2435353&terms=cars.

The administration server 18 redirects the request 46 to merchant server 20 as a request 48. Redirected request 48 includes the ID of operator of the affiliate server 14 and the data necessary for merchant server 20 to respond to consumer computer 12 in an appropriate manner to the redirected request 46. In the following example request 48, the ID of operator of the affiliate server 14 is “1234” and the search term “cars” is the additional data provided: http://www.netcarsearch.com/own/?SID=1234&terms=cars.

The merchant server 20 responds to consumer computer 12 and a series of requests and responses 50 occurs between them that may result in a sale to the consumer. Tracking software installed on merchant server 20 monitors the requests and responses 50 for a sale to take place. The tracking software is alerted to start tracking by the ID of operator of the affiliate server 14 in the incoming request 48. Alternatively, the tracking software detects cookies on all computers that send requests to merchant server 20. Hence, even if the customer does not make a purchase during the initial series of requests and responses 50, but returns on another occasion, the tracking software may detect the cookie 42 and, if a sale takes place on that occasion, will treat the sale as if it had taken place during the series of requests and responses 50. However, it is possible with conventional web browsers that users can delete cookies or configure the browser to not accept cookies.

If a sale takes place during the series of requests and responses 50 (or on a later visit by the consumer), the tracking software installed on merchant computer 20 sends an encrypted report 52 to the administration server 18 providing the ID of operator of the affiliate server 14 and the commission to be paid to the affiliate 14. That data is stored and used by the operator of the administration server 18 to pay, or arrange for payment of, the appropriate commission to the affiliate 14. Other data may also be sent in report 52, such as identification of the goods or services sold. That other data may be useful in improving the ranking process as described below.

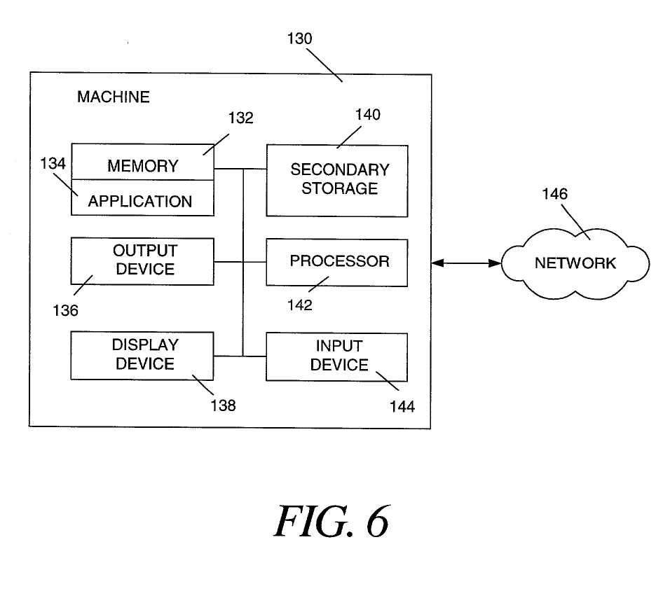

The consumer returns to the search result page and selects the hyperlink associated with merchant Q on the search results page shown in FIG. 6. A request 54 is sent to the third party transaction-tracking server 28 containing the ID of the merchant Q, the ID of the operator of the administration server 18, and the ID of the operator of the affiliate 14. The third party transaction-tracking server 28 redirects the request to the merchant's server 22. The redirected request 56 includes the ID of the operator of the affiliate 14 and the data necessary for the merchant server 22 to respond to the consumer computer 12.

The merchant server 22 responds to consumer computer 12 and a series of requests and responses 58 occurs between them that may result in a sale to the consumer. As will be discussed in further detail below in relation to database B, tracking software installed on merchant server 22 monitors the requests and responses 58 for a sale to take place. The tracking software is alerted to start tracking by the ID of operator of the affiliate server 14 in the incoming redirected request 56. Alternatively, the tracking software detects cookies on all computers that send requests to merchant server 22. Hence, even if the customer does not make a purchase during the initial series of requests and responses 58, but returns on another occasion, the tracking software may detect the cookie 42 and, if a sale takes place on that occasion, will process the sale as if it had taken place during the series of requests and responses 58.

If a sale occurs during the series of requests and responses 58 (or on a later visit by the customer), the tracking software installed on merchant computer 22 sends an report 60, possibly encrypted, to the third party transaction-tracking server 28 providing the ID of operator of the affiliate server 14 and the commission to be paid to the affiliate 14. Other data may also be sent in report 60, such as identification of the goods sold. That other data may be useful in improving the ranking process as described below.

The data contained in the report 60 is in turn transmitted in an report 62, possibly encrypted, to the administration server 18, where it is stored and used by the operator of the administration server 18 to pay, or arrange payment of, the appropriate commission to the affiliate 14. The details of how the commission is calculated are discussed below.

The consumer selects the hyperlink associated with merchant R on the search results page. A request 64 is sent to the administration server 18 and contains the ID of the merchant R. For example, in the following the ID of the merchant R is “5646546”:

http://www.admoneylink.com/cgi-bin/j ackhammer.cgi?merID=5646546.

The administration server 18 redirects the request 64 to the merchant server 24, the redirected request 66 having been modified so that the return address is the consumer's computer 12. The administration server 18 deducts funds for a “click-through” from the merchant R's account, as will be explained further below.

Merchant server 24 responds directly to consumer computer 12 and a series of requests and responses 68 occurs. However, since merchant R is paying a commission to the operator of administration server 18 based upon click-throughs, there is no need for tracking software installed on merchant server 24 and no need for reporting or tracking of a sale that occurs to the consumer.

The consumer clicks the hyperlink associated with merchant S on the search results page. A request 70 is sent to the third party search engine server 30 that contains data that was returned by the third party search engine server 30 in response to the search request by the search engine server 16. The third party search engine server 30 redirects the request to the merchant's server 26, modifying the request 70 so that the return address is the consumer's computer in the redirected request 72. The third party search engine server 30 then deducts funds for a click-through from the merchant S's account and saves data to calculate payment to the operator of the search engine server 16.

Merchant server 26 responds directly to the consumer computer 12 and a series of requests and responses 74 occurs. However, since merchant S is paying a commission to the operator of third party search engine server 30 based upon click-throughs, there is no need for tracking software installed on merchant server 26 and no need for reporting or tracking of any sale that occurs to the consumer. The third party search engine server 30 reports click-through data 76 to the administration server 18.

Merchants found in searches of databases A and B can ranked in the search results 44 in a variety of ways. The following provides examples of ranking methodologies.

A first type of ranking uses the ratio of the payout by a merchant on all sales to the number of clicks sent to the merchant, independent of which affiliate's search box sent the consumer to the merchant's site. This ratio is determined without regard to a merchant's primary business. The primary business may constitute the type of goods or services that generate the most revenue for the merchant. For example, a web site may sell books as its main source of revenue and also sell some compact disks.

A second type of ranking uses the ratio of payout by a merchant on all sales relating to the merchant's primary business to the number of clicks sent to the merchant, independent of which affiliate's search box sent the consumer to the merchant's site .

A third type of ranking uses the ratio of payout by a merchant on all sales relating to the merchant's primary business to the number of clicks sent to the merchant from search results lists resulting from searches including search terms relating to the merchant's primary business, independent of which affiliate's search box sent the consumer to the merchant's site.

A fourth type of ranking uses the ratio of payout by a merchant on all sales resulting from clicks sent to the merchant from search results lists generated from the search box on the affiliate's site to total number of clicks sent to the merchant from search results lists generated from the search box on the affiliate's site.

A fifth type of ranking uses the ratio of payout by a merchant on all sales relating to the merchant's primary business and resulting from clicks sent to the merchant from search results lists generated from the search box on the affiliate's site to the total number of clicks sent to the merchant from search results lists generated from the search box on the affiliate's site where the search terms were related to the merchant's primary business. This is limits the ranking even further.

### Affiliate Marketing Search Facility System

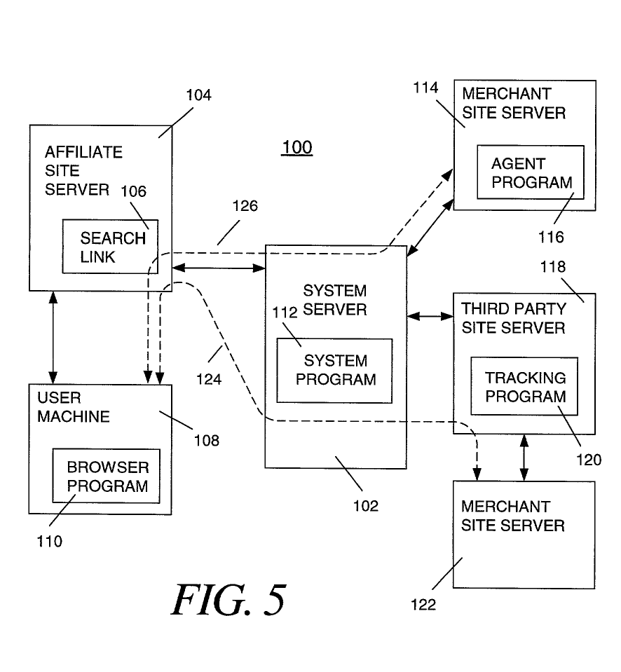

FIG. 5 is diagram of an exemplary system 100 for performing searches, ranking merchants, and providing commissions for referrals to implement the methodologies described above. System 100 includes an affiliate site server 104 that includes a search link 106. Affiliate site server 104 may correspond with server 14 and represent, for example, a content site accessed by users by the Internet or other network, and it may represent sites maintained by or associated with affiliate marketing entities as identified above. For example, it may constitute a news web site having text, graphics, and pictures for news items. However, it can be implemented with any type of content site.

A user machine 108 may correspond with consumer computer 12 and include a browser program 110 for interacting with affiliate site server 104. A user or customer at user machine 108 may enter a search query through search link 106, and affiliate site server 104 may transmit the search query to a system server 102. A search query constitutes, for example, one or more words to be searched and can possibly include Boolean operators for the query when it contains multiple words or terms to search. The search link 106 is typically associated with a section in a displayed page or screen for the user to enter a search query. The link may be implemented with an embedded network address such as a URL associated with the search section and identifying the network address for system server 102. The search section, as described below, can be configured in various ways for presentation depending upon, for example, the content of the affiliates site server 104.

System server 102 may correspond with servers 16 and 18, and it includes a system program 112 for controlling operation of the system server and performing methods to implement the methodologies described above. Those methods may include, for example, ranking merchants for display, performing searches, and providing commissions for referrals. System server 102 may interact with a merchant site server 114, which can include an agent program 116 for gathering data concerning purchases or other activity by users and transmitting it back to system server 102. Merchant site server 114 represents a server maintained by or associated with a particular merchant for providing information about products or services offered by the merchant and permitting a user to make on-line purchases of them.

System server 102 may also interact a the third party site server 118, which provides access to a merchant site server 122. Third party site server 118 may correspond with servers 28 and 30, and it can include a tracking program 120 for recording information concerning purchases and other activity by users. Third party site server 118 represents, for example, a site that has relationships with a multitude of merchant sites and thus can provide a convenient way to have access to many merchant sites. Third party site server 118 typically performs the service of tracking and recording purchases for various purposes and can eliminate the requirement for system server 102 to track that type of information for particular merchant sites. Merchant site servers 114 and 122 may correspond with servers 20, 22, 24, and 26.

In use, the search query entered through search link 106 is transferred to system server 102 along with related information. Affiliate site server 104 also transfers a user's network connection. Since a typical system may include many affiliate site servers, the related information transferred can include an identification of the affiliate site server that transferred the search query and user's connection, and that identification can be used to track the user's on-line activity in order to provide for referral commissions back the affiliate site server or its operator. In response to the transfer by the affiliate site server, system server 102 receives the search query and can perform a search within local databases for merchants that relate to the search query, and may also use links to third party site server 118 to perform the search in other databases using the search query. The search can involve any type of searching technique for identifying merchants potentially related to the search query. Therefore, the results of the search query typically produce identifications of one or more merchants relating to the search.

System server 102 may rank those identified merchants according to a particular criteria, as explained below. Those identifications of merchants are then displayed to the user as the results of the search. They may be displayed using, for example, a name of the merchant or corresponding web site linked with a network address for the web site displayed within a screen or an HTML web page. If the user selects one of the identified merchants, system server 102 may transfer the user's network connection the selected merchant site, such as merchant site server 114 or third party site server 118 for a subsequent transfer to merchant site server 122. In addition, system server 102 may also transfer the search query and possibly other information along with transferring of the user's network connection. The other information may include, for example, an identification of the affiliate site server that originally transferred the user's network connection for use in possibly paying referral commissions back to that affiliate site server or its operator. The user may then navigate on-line through the merchant site using, for example, conventional web browsing techniques, and the user may potentially make on-line purchases, which are tracked and recorded.

Lines 124 and 126 illustrate how a user's network connection may be transferred among the various servers. Line 126 represents a transfer from affiliate site server 104 to system server 102 in response to an entered search query and another transfer from system server 102 to merchant site server 114 in response to a selection of that merchant in the displayed search results. Line 124 represents a transfer from affiliate site server 104 to system server 102 in response to an entered search query and another transfer from system server 102 to merchant site server 122, via third party site server 118, in response to a selection of that merchant in the displayed search results.

The connections between the servers and user machine in system 100 represent, for example, communications over a network such as the Internet. Those communications can occur using, for example, conventional communication protocols such as TCP/IP. The transfer of the user's network connection, as represented by exemplary connections of lines 124 and 126, can occur using, for example, conventional hyperlinking techniques and manipulation of URLs with TCP/IP techniques. Alternatively, any type of network communication can be used, along with any technique for transferring a user's connection among servers or other machines. Also, the various network communications can occur over wireline or wireless networks.

One server or machine for each of the various entities is shown in FIG. 5 for illustrative purposes only. Typically, system 100 may include multiple user machines 108, affiliate site servers 104, merchant site servers 114, third party site servers 118, and merchant site servers 122.

FIG. 6 depicts a machine 130 illustrating exemplary hardware components of system server 102 and other machines and servers used by system 100. Machine 130 includes a connection with a network 146 such as the Internet or other type of computer networks. Machine 130 typically includes a memory 132, a secondary storage device 140, a processor 142, an input device 144, a display device 138, and an output device 136.

Memory 132 may include random access memory (RAM) or similar types of memory, and it may store one or more applications 134 for execution by processor 142. Applications 134 may correspond with software modules to perform processing for the functions described below. Secondary storage device 140 may include a hard disk drive, floppy disk drive, CD-ROM drive, or other types of non-volatile data storage, and it may correspond with the various databases identified in this description. Processor 142 may execute applications or programs stored in memory 132 or secondary storage 140, or received from the Internet or other network 146. Input device 144 may include any device for entering information into machine 130, such as a keyboard, key pad, cursor-control device, touch-screen (possibly with a stylus), or microphone. Display device 138 may include any type of device for presenting visual information such as, for example, a computer monitor, flat-screen display, or display panel. Output device 136 may include any type of device for presenting a hard copy of information, such as a printer, and other types of output devices include speakers or any device for providing information in audio form. Machine 130 can possibly include multiple input devices, output devices, and display devices.

Although machine 130 is depicted with various components, one skilled in the art will appreciate that this machine can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling machine 130 to perform a particular method.

### Affiliate Marketing Search Facility Methods

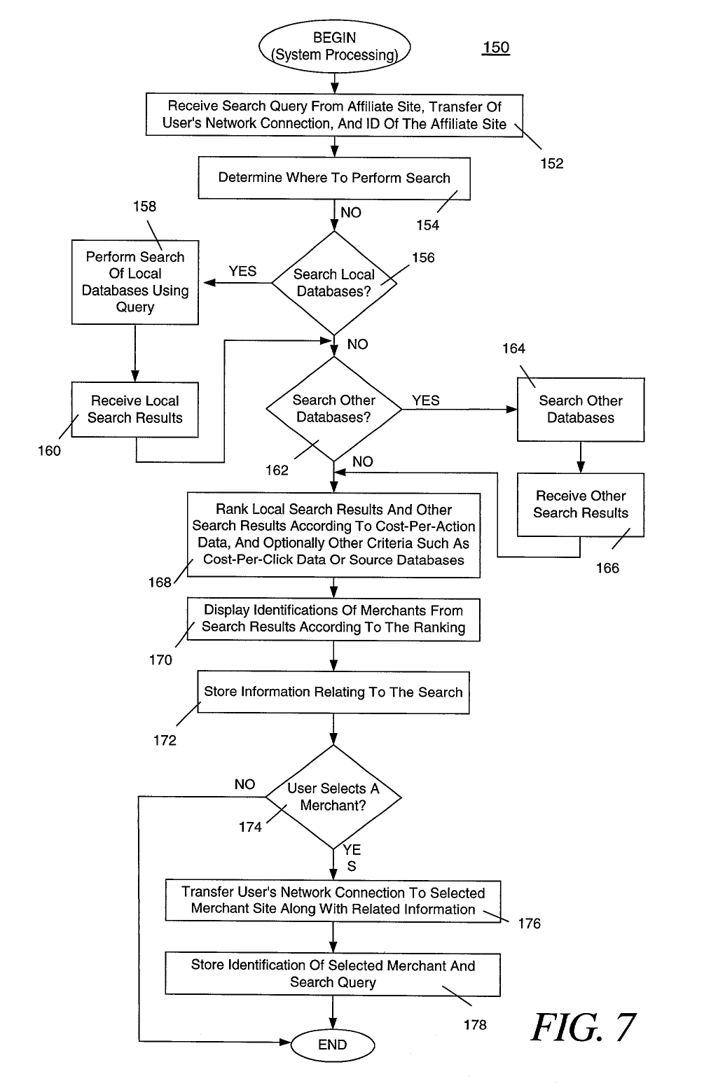

FIG. 7 is a flow chart of a system processing method 150 for execution by system server 102. Method 150 can be implemented in, for example, software modules for execution by system server 102. In method 150, system server 102 receives a search query from an affiliate site server such as server 104, and receives transfer of a user's network connection along with an identification of the affiliate network site (step 152). The identification of the affiliate network site can be implemented with, for example, a webmaster ID or any information identifying the affiliate site.

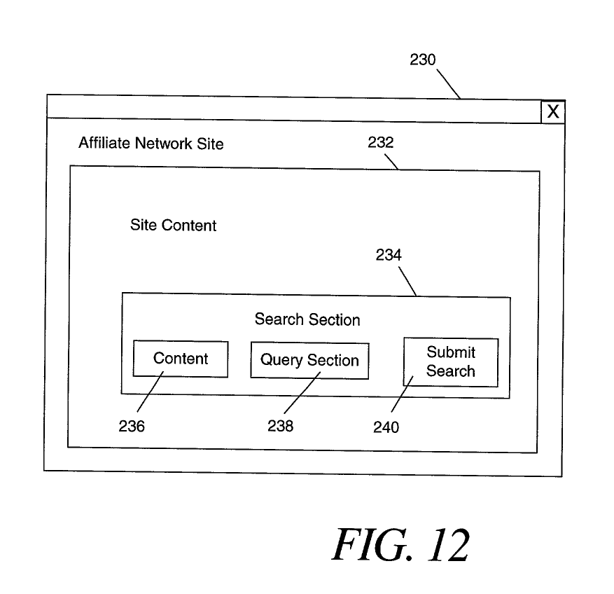

FIG. 12 is a diagram of an exemplary affiliate network site screen 230 that may originate the transfer of the user's network connection. Screen 230 may be configured, for example, as a page formatted in HTML for presentation on a display device using a web browser. Screen 230 may include site content 232, which can constitute any type of content depending upon the nature of the affiliate site. For example, it may include text, graphics, pictures, animations, movies, or various multimedia content.

Within or associated with site content 232 is a search section 234, including optional content 236, a query section 238, and a submit search section 240. Query section 238 permits the user to enter a search query, such as one or more terms to be searched. The submit search section 240 can be selected by a user in order to submit the search query entered in section 238 to the affiliate network site server.

Query section 238 can be represented, for example, as a box or any configuration of a particular area in section 234 for a user to enter a search query. Content 236 can include any type of content for search section 234 and, alternatively, search section 234 can include no particular content and simply be a place for a user to enter a search query. Content 236 permits configuration of section 234 as a tailored search section, meaning that the content 236 is tailored to site content 232 or according to other factors relating to the affiliate network site. Content 236 can include, for example, text in various languages, various colors, graphics, pictures (JPEGs), animation or movies (MPEGs), or various multimedia content.

As an example, if affiliate network site 230 provides content concerning automobiles, then content 236 may include a picture and text for a popular automobile or possibly a rotating slide show featuring pictures of various automobiles. A language for the text can be selected based upon, for example, the language of text within site content 232. As another example, if affiliate network site provides content concerning pets, then content 236 may include a picture of a pet. Therefore, search section 234 includes the flexibility to be configured or tailored to various types of affiliate network sites, possibly as desired by the entity operating the site. In addition, the search section 234 can be tailored dynamically or generated from configured search sections. For example, system server 102 can store a variety of search sections, and the entity operating an affiliate network site can select one or more of them. Using configured search sections can, for example, alleviate the need to design and configure one for each particular affiliate network site.

Also, a location of search section 234 within screen 230 can be determined based upon content 232 of the site or other criteria. For example, it can be located in the center part of screen 232 in order to best be seen and detected by the user and also positioned around the particular site content 232. As another example, it can be located in a comer of the screen if, for example, an operator of the affiliate network site prefers to emphasize its own content and have the search section 234 in a less conspicuous position on the screen.

Search section 234, content 236, and sections 238 and 240 are shown as a rectangular for illustrative purposes only. Sections 234, 238, and 240 can be implemented with any geometrical or irregular shape, and content 236 can be implemented with any type of content in any configuration. Also, content 236 can possibly extend beyond search section 234 in order to, for example, blend with site content 232.

In method 150, system server 102 determines where to perform a search of the user's search query received in step 152 (step 154). This search may include, for example, searches of merchants identified within local databases accessed by system server 102 such as merchant site 114, and merchants identified within other databases. A determination of where to perform the search may depend upon various criteria and may include one or more databases identifying merchants.

System server 102 determines if it should search within its local databases (step 156). If so, it performs a search of the local databases using the search query (step 158), and receives local search results (step 160). The search can be performed using any number of techniques and, for example, conventional search engines in order to identify merchant sites that potentially relate to the search query. For example, the search query may identify a particular type of product desired by the user, and the search results may identify merchants selling those types of products.

System server 102 also determines whether to search in other databases (step 162). If so, it searches in other databases, possibly using links to the third party site server 118 (step 164), and may receive other search results (step 166). System server 102 can perform all of the searches, or possibly use other servers to perform part or all of the searches.

When performing the searching in steps 156 and 162, system server 102 can optionally bias the search results. This biasing can occur by the system server automatically adding a term to the search query and searching for that term in combination with the user's entered query. For example, if the user was referred by an affiliate site that has information on cars, the system server may automatically add the term “cars” to the query and search for “cars” in combination with the user's query. Consider, for example, that the user entered the search term “books” on the affiliate car web site; in this example, the system server will search for “cars+books.” In this manner, the system can optionally bias the search based upon, for example, the particular affiliate sites referring users.

System server 102 ranks the local search results and other search results according to cost-per-action data, and optionally other criteria such as cost-per-click data or source databases (step 168). The ranking can be based upon various criteria, such as the methodologies described above, and the formulas and techniques described below. It can optionally include an initial human-entered modification to the ranking.

The ranking can also include categorizing the merchants. Therefore, the merchants can be both categorized and ranked within each category. Table 1 illustrates an example of categorization of merchants.

TABLE 1

| Category | Description |
|---|---|
| A | Merchants having a direct relationship with the system server |
| | (for example, merchants 114) and who pay commissions |
| | based upon a cost-per-action |
| B | Merchants having an indirect relationship with the system |
| | server (for example, merchants 122 accessed via third party |
| | site server 118) and who pay commissions based upon a cost- |
| | per-action |
| C | Merchants having a direct relationship with the system server |
| | (for example, merchants 114) and who pay commissions |
| | based upon a cost-per-click |
| D | Merchants having an indirect relationship with the system |
| | server (for example, merchants 122 accessed via third party |
| | site server 118) and who pay commissions based upon a cost- |
| | per-click |

In this example, merchants are placed in one of the categories A-D based upon their relationship with system server 102, or an entity operating system server 102, and the type of commissions that they pay for referrals from the affiliate sites. The merchants are ranked within each category according to various possible ranking methodologies. Categorization can be useful, for example, to prioritize the merchants and possibly give preference to particular merchants based upon their relationship with the system server or the entity operating it. Therefore, merchants having a direct relationship, for example, may be given priority and displayed to a user within search results before display of merchants having an indirect relationship. Table 1 is an example of categorization provided for illustrative purposes only, and categories are not required.

Step 168, whether or not processing categories, involves ranking of merchants. Step 168 can process data to rank merchants or, alternatively, rank them according to pre-processed data or predetermined rankings. The ranking can involve various methodologies such as those described above.

One type of ranking involves or is based upon calculating a cost-per-action ratio. In a cost-per-action, the “cost” is the amount or percentage that a merchant pays for each successful action, and the “action” is a successful action as possibly defined by the merchant. Typically, a successful action is defined as a purchase by the user or customer. However, merchants can define other activity by the user as a “successful action” and have that defined activity used for calculating the cost-per-action ratio. For example, a merchant may agree to pay $1 as a referral commission for each purchase or pay 5% of the purchase price; in this example, the cost-per-action is $1 or 5%. These numbers are provided for illustrative purposes only. At least a portion of the cost-per-action commission is typically paid back to the entity operating the affiliate site server 104 by tracking transfer of the user's network connection as described above.

In addition, a merchant may agree to pay various cost-per-action ratios depending upon particular criteria. For example, a user's search query can be tracked and a particular a cost-per-action ratio (amount or percentage) can be paid based upon the search query. Typically, the merchant's primary business in relation to the search query is also used for this type of cost-per-action ratio.

For example, consider an on-line book web site that sells books as its primary business and also sells movies on video tapes as a secondary business. In this example, a user searches for “books” and, after linking to the on-line book web site, makes a purchase. Consider a second scenario for this example where a user searches for “videos” and, after linking to the on-line book web site, makes another purchase. The on-line book web site may agree, for example, to pay $1 as a cost-per-action ratio for the purchase resulting from the search for “books” (the primary business) and pay $0.50 for the purchase resulting from the search for “videos” (the secondary business). Therefore, various cost-per-action ratios (amounts or percentages) can be paid based upon the search query or terms entered by the user and by tracking those terms along with the referrals resulting in transfer of the user's network connection to various merchant web sites.

By passing along the search terms, the agent program 116 in merchant server 114, or the tracking program 120 in third party site server 118, can determine which cost-per-action ratio to select. The various ratios can be stored in a local database for system server 102, for example, and associated with corresponding search terms. Table 2 illustrates conceptually a structure to associate cost-per-action ratios with terms for a particular merchant. The same structure can be repeated for other merchants. The values in the entries for Table 1 are used only to conceptually illustrate parameters and are not necessarily indicative of the parameter values.

TABLE 2

| Cost-Per-Action (CPA) | |
|---|---|
| Ratio for Merchant X | Search Terms |
| CPA 1 | Term 1a, term 1b, . . . term 1n |
| CPA 2 | Term 2a, term 2b, . . . term 2n |
| . . . | |
| CPA N | Term Na, term Nb, . . . term Nn |

Another type of ranking for use in step 168 involves or is based upon calculating a cost-per-click ratio. In a cost-per-click, the “cost” is the amount that a merchant pays for each “click” or collection of “clicks,” and the “click” is a user's on-line selection of the merchant's network site or web site. For example, search results can include a list identifying merchants and linked with the merchants' URLs; when a user selects one of the merchant identifications, that action is considered a “click” and the user's network connection is transferred to the merchant site. The “click” thus represents a user accessing a particular merchant site. A “click” can also include, for example, a user selecting an on-line banner for a merchant, which results in transfer of the user's network connection to the web site for the merchant who sponsors the banner. “Clicks” can involve other on-line activity as well. These “clicks” may represent, for example, the use of a cursor control device to select (“click on”) content or an item within a displayed screen.

These various clicks can be tracked and recorded for each merchant. The merchants typically agree to pay an amount for a certain number of clicks; for example, a merchant may agree to pay a $10 commission for every 1,000 clicks. At least a portion of the cost-per-click commission is typically paid back to the entity operating the affiliate site server 104 that transferred the user's network connection by tracking the transfer as described above.

The cost-per-click commissions paid to the referring affiliate sites can alternatively be based upon various criteria. For example, the amount can be a percentage of the cost-per-click commissions paid by the merchants resulting from the referrals. Alternatively, the total cost-per-click revenue (the cost-per-click commissions from all merchants) can be pooled, and a particular percentage of the pooled amount can be paid to the affiliate sites based upon various criteria such as the cost-per-action commissions. For example, the system can track the cost-per-action commissions based upon the referring affiliate sites and calculate for each affiliate site the percentage of the cost-per-action revenue (commissions) that resulted from referrals from that site.

The following formula represents, for this example, the amount of the pooled cost-per-click revenue to pay to a particular affiliate site: percentage of pooled cost-per-click revenue for affiliate site X=(amount of the cost-per-action revenue resulting from referrals from affiliate site X)/(total amount of the cost-per-action revenue from all merchants). As an example, consider that the total cost-per-action revenue is $1,000 from all merchants and that affiliate site X provided referrals resulting in $100 in cost-per-action revenue; in this example, the affiliate site X receives 10% ($100/$1,000) of the pooled cost-per-click revenue.

System 102 can maintain a database structure to track and record the cost-per-action revenue (commissions) resulting from the referrals from each participating affiliate site. That structure can also be used to calculate the total cost-per-action revenue by performing a summation of individual cost-per-action revenues. Table 3 illustrates conceptually a structure to associate affiliate sites with cost-per-action revenue.

TABLE 3

| Affiliate Site | Affiliate Cost-Per-Action Revenue |
|---|---|
| Affiliate Site 1 | Cost-Per-Action Amount 1 |
| Affiliate Site 2 | Cost-Per-Action Amount 2 |
| . . . | |
| Affiliate Site N | Cost-Per-Action Amount N |
| Total Cost-Per-Action Revenue | Summation of Amounts 1-N |

System server 102 can also maintain a database structure to track and record the percentages of the cost-per-click pooled revenue for each affiliate site for the example provided above. Table 4 illustrates conceptually a structure to track these amounts in conjunction with the information recorded in Table 3. The values in the entries for Tables 3 and 4 are used only to conceptually illustrate parameters and are not necessarily indicative of the parameter values.

TABLE 4

| | Affiliate Site |
|---|---|
| Affiliate Site | Percentage of Pooled Cost-Per-Click Revenue |
| Affiliate Site 1 | Amount 1 / (Summation of Amounts 1-N) |
| Affiliate Site 2 | Amount 2 / (Summation of Amounts 1-N) |
| . . . | . . . |
| Affiliate Site N | Amount N / (Summation of Amounts 1-N) |

The above calculations represent only examples of cost-per-action and cost-per-click commissions and other calculation or formulas can be used. Also, as indicated, step 168 can involve calculating the rankings or retrieving rankings already determined. For example, based upon the above calculations, merchants can be ranked in order of priority based upon the amount of commissions they have paid for referrals, with merchants paying more in commissions receiving a higher priority.

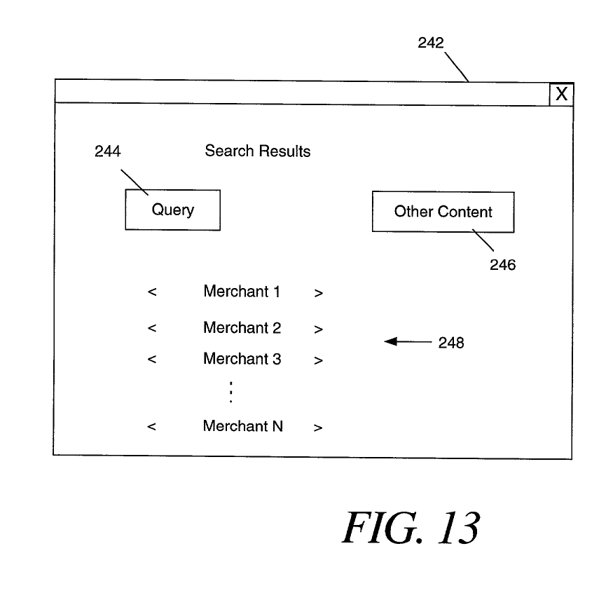

System server 102 then displays identifications of merchants from the search results according to the ranking (step 170). The displays can be based upon the rankings in various ways and can also use the optional categorization of merchants described above. For example, FIG. 13 is a diagram of a exemplary search results screen 242. Screen 242 may be implemented with, for example, a web page formatted in HTML for presentation on a display device using a web browser. Screen 242 may include a query section 244 for displaying the user's search query. It may also include other content 246, which may include any type of content displayed and configured in any way. Screen 242 also displays at least a portion of the results of the search, typically using names or other identifiers for the merchants identified in the search, as illustrated in section 248. Each display of merchants may be linked with a network address, such as an embedded URL, for that merchant. Therefore, if the user selects one of the identified merchants 248 by, for example, “clicking” on it, the user's network connection is transferred to the merchant site using the embedded URL.

Merchants are typically listed in section 248 based upon their ranking. For example, merchants are listed from highest ranked or priority (merchant 1) to lowest ranked or priority (merchant N). Also, the list of identified merchants can be included on multiple pages or screens, requiring the user to select a next page to view additional portions of the list. Therefore, higher ranked merchants are typically listed before lower ranked merchants in the search results and those higher ranked merchants are likely to be viewed by a user before viewing of the lower ranked merchants. That type of listing may increase the likelihood that higher ranked merchants are selected by a user before possible selection of lower ranked merchants.

Step 170, possibly in conjunction with step 168, involves configuring identifications of the merchants for display based upon the rankings. For example, particular merchants may be ranked higher based upon the commissions they have paid and the higher ranking can mean that they are listed before lower ranked merchants in the displayed search results. Merchants can also be prioritized for display based upon the categorization. Table 5 illustrates an example of a prioritization of merchants for display based upon the categories provided in Table 1.

TABLE 5

| Priority for Display | Merchant |
|---|---|
| 1 | Category A Merchants |
| 2 | Category B Merchants |
| 3 | Category C Merchants |
| 4 | Category D Merchants |

In the example shown in Table 5, merchants are displayed in search results in the order of their priority from priorities 1-4.

The order or priority for display can be based upon the cost-per-action ratios paid by each merchant. Those merchants with higher amounts or percentages for the cost-per-action ratios can be given priority over merchants paying lower amounts or percentages. The order or priority for display can also be based upon the actual commissions paid by the merchants, and those merchants having paid more commissions can be given priority over merchants having paid less in commissions. System server 102 can record the cost-per-action and cost-per-click ratios for each merchant and track the commissions paid by each merchant for use in determining the ranking. Tables 6 and 7 illustrate conceptually structures for recording this information for merchants paying, respectively, a cost-per-action commission and a cost-per-click commission. The values in the entries for Tables 6 and 7 are used only to conceptually illustrate parameters and are not necessarily indicative of the parameter values. For Table 6 each merchant can have multiple cost-per-action ratios as described above.

TABLE 6

| | | |
|---|---|---|
| Merchant | Cost-Per-Action (CPA) Ratio | Commissions Paid |
| Merchant 1 | CPA Ratio 1 | Amount 1 |
| Merchant 2 | CPA Ratio 2 | Amount 2 |
| Merchant N | CPA Ratio N | Amount N |

TABLE 7

| Merchant | Cost-Per-Click (CPC) Ratio | Commissions Paid |
|---|---|---|
| Merchant 1 | CPC Ratio 1 | Amount 1 |
| Merchant 2 | CPC Ratio 2 | Amount 2 |
| . . . | | |
| Merchant N | CPC Ratio N | Amount N |

If both categorization and cost-per-action revenue is used for ranking, then the system can, for example, rank according to the categories as illustrated in Table 5 and rank merchants within each category as described above. For example, in categories A and B the merchants can be ranked in order of priority based upon the amount of cost-per-action commissions paid with merchants having paid more in commissions receiving higher priority. In categories C and D, the merchants can be ranked, for example, based upon the amount of cost-per-click commissions paid. Accordingly, based upon various criteria the system can determine an order for displaying identifications of merchants in the search results.

Although any of the above criteria can be used, a preferred ranking includes determining an equivalent cost-per-click ratio for each merchant. In particular, the system calculates and stores for each merchant the following ratio: total commissions paid by the merchant/total clicks sent to the merchant's site. The “clicks” represent transfers of users' network connections when the users select particular merchants. The system typically records this information using system program 112, agent program 116, and tracking program 120, and therefore has the information available for use in calculating the equivalent cost-per-clicks, as well as for other purposes.

The system then ranks the merchants from the highest equivalent cost-per-click ratio to the lowest equivalent cost-per-click ratio. For example, if a first merchant paid $1,000 in commissions based upon 50 clicks sent, the first merchant has an equivalent cost-per-click ratio of $20 ($1,000/50); if a second merchant paid $1,500 in commissions based upon 100 clicks sent, the second merchant has an equivalent cost-per-click ratio of $15 ($1,500/100). In this example, the first merchant is ranked higher than the second merchant based upon the higher equivalent cost-per-click ratio.

Table 8 illustrates conceptually a structure for recording this information for equivalent cost-per-clicks. The values in the entries for Table 8 are used only to conceptually illustrate parameters and are not necessarily indicative of the parameter values.

TABLE 8

| Merchant | Commissions Paid | Clicks Sent | Equivalent CPC |
|---|---|---|---|
| Merchant 1 | Amount 1 | Clicks 1 | Amount 1 / Clicks 1 |
| Merchant 2 | Amount 2 | Clicks 2 | Amount 2 / Clicks 2 |
| . . . | | | |
| Merchant N | Amount N | Clicks N | Amount N / Clicks N |

System server 102 may also store information relating to the search, such as an identification of the affiliate site server 104 that transmitted the search along with the actual search query (step 172). The user can then possibly select an identified merchant within the displayed listing in section 248 of screen 242. If the user selects (“clicks on”) a merchant (step 174), system server 102 transfers the user's network connection to the selected merchant site, possibly via third party site server 118, along with related information, such as an identification of the affiliate network site referring the user and an ID for it such as the webmaster ID (step 176). System server 102 may also store an identification of the merchant selected and associate it with the query in order, for example, to track search queries and results for statistical or other purposes (step 178).

System server 102, possibly as part of step 178, can also log additional or other information pertaining to every click sent out to any link in the search results page, for example, screen 242. For example, the logged information can include the following: the time and date of the click; the webmaster ID of the referring affiliate site; the queried term or terms; and the merchant ID. The logged information can be used by system server 102 to perform the calculations for the rankings of merchants identified in, for example, databases A and B described above.

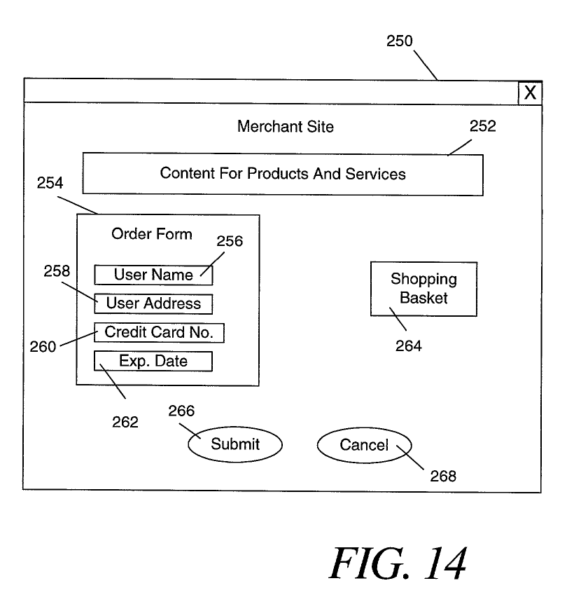

FIG. 14 is a diagram of an exemplary merchant site screen 250, which a user may view after selection of and transfer to a merchant site. Screen 250 can be implemented with, for example, a web page formatted in HTML for presentation on a display device using a web browser. Screen 250 may include content for products and services 252 offered by the merchant, and that content may include any type of content for identifying or describing the products and services, such as text, graphics, pictures, animations, movies, or multimedia content. Screen 250 may also include an on-line shopping basket 264 to record purchases by the user, and an electronic order form 254 for the user to execute an on-line purchase. Order form 254 may include, for example, a name section 256 to receive a user name, an address section 258 to receive a user address, and sections 260 and 262 to receive a credit card number and associated expiration date. A user may select a submit section 266 to submit the purchase request, or select a cancel section 268 in order to cancel the purchase.

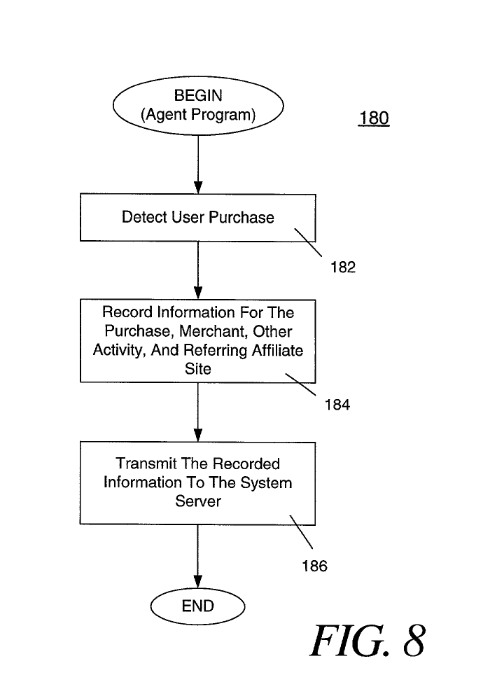

FIG. 8 is a flow chart of an agent program method 180 implemented by agent program 116 within merchant site server 114. Method 180 can be implemented with, for example, software modules for execution by merchant site server 114. In method 180, agent program 116 detects a user purchase at the merchant site (step 182). Agent program 116 records information for the purchase, merchant, other activities, and a referring affiliate network site (step 184). It transmits that information to system server 102 for processing (step 186). This agent program 116 implements these steps in addition to software already existing on the merchant site server to execute the user's purchase request. The information gathered by the agent program 116 for tracking purposes can include, for example, the information in Table 9 for each purchase or other on-line activity.

TABLE 9

| Purchase | Tracking Information |
|---|---|
| Purchase No. | Webmaster ID for referring affiliate site |
| | Amount of the purchase |
| | Number of clicks relating to the purchase |
| | Date and time of the purchase |
| | Commission amount to be paid for the purchase |
| | Search query terms that resulted in the purchase |
| . . . | |

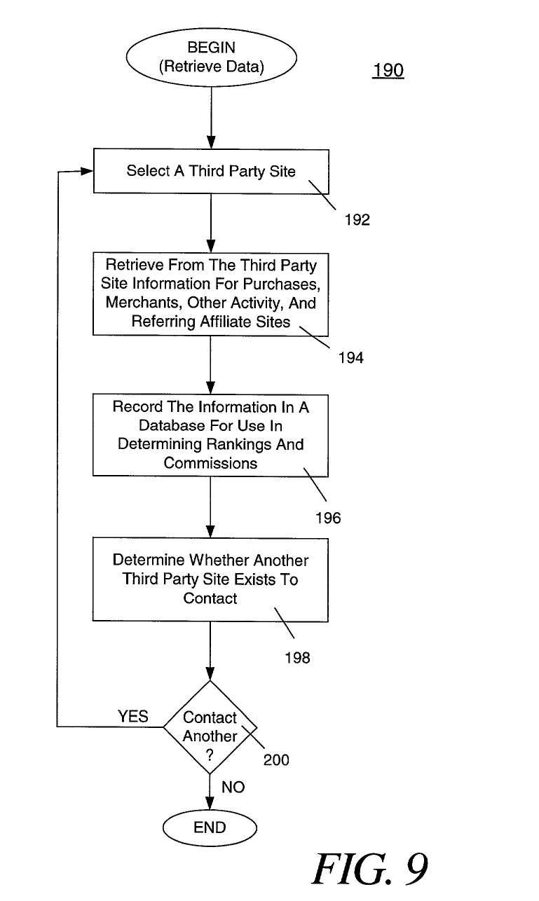

FIG. 9 is a flow chart of a retrieve data method 190 for retrieving information concerning purchases and other activity from third party site server 118. Method 190 can be implemented with, for example, software modules for execution by system server 102. In method 190, system server 102 selects a particular third party site (step 192). It contacts that site via the network, such as the Internet, and retrieves from the third party site information for purchases, merchants, other activity, and referring affiliate sites (step 194). That information may include, for example, the information provided in Table 9 for each purchase or other on-line activity.

System server 102 records the information in a database for use in determining rankings and commissions (step 196). It also determines whether another third party exists to contact (step 198); if another site exists (step 200), it returns to step 192 to execute method 190 again. System 100 may typically include many third party site servers 118, and system server 102 may store the identification of those sites along with information for use in contacting them such as a network address for each of the sites.

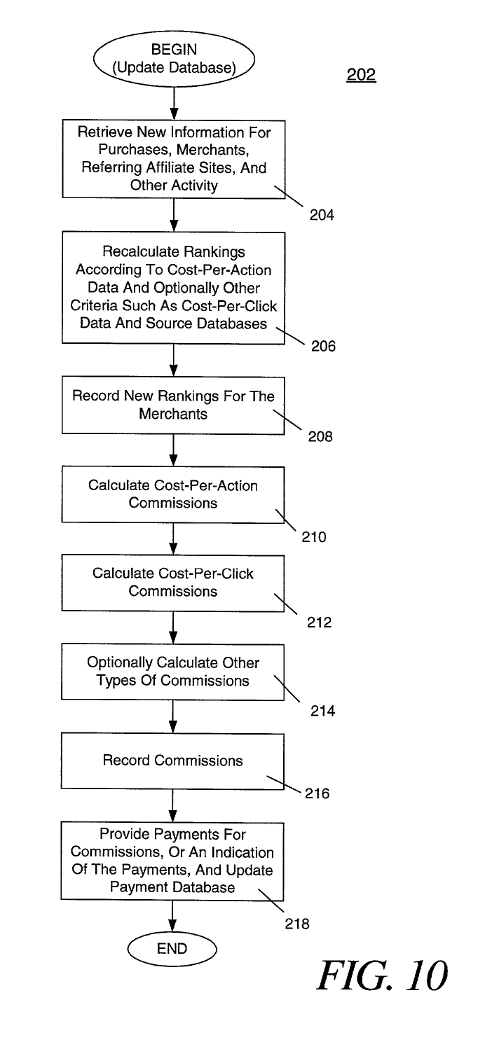

FIG. 10 is a flow chart of an update database method 202. Method 202 can be implemented with, for example, software modules for execution by system server 102. In method 202, system server 102 retrieves new information for purchases, merchants, referring affiliate sites, and other activity (step 204). It may retrieve this information as collected and stored by the methods 180 and 190 described above. System server 102 can recalculate the rankings according to cost-per-action data and optionally other criteria such as cost-per-click data and source databases (step 206). Those calculations can be accomplished using methodologies described above or the techniques above with respect to step 168.

System server 202 can record the new rankings for the merchants (step 208). System server 102 may also calculate the commissions to provide to the affiliate site servers. For example, it can calculate a cost-per-action commission, (step 210), a cost-per-click commission (step 212), and optionally calculate other types of commissions (step 214). It records the commissions (step 216), and can provide payments for the commissions, or otherwise arrange for payment, and update the payment database (step 218). The system can automatically provide payments or it may simply transmit to the affiliate site an indication of the payments to which they are entitled such as in a commission report.

Table 10 illustrates conceptually a structure to record rankings for merchants and optionally identify commissions paid. The commissions paid can alternatively be identified by cost-per-action commissions paid and cost-per-click commissions paid. In this example, the ranking can be implemented with a number indicating an order in which to display merchants in search results as described above. Alternatively, a ranking can include any information for use in prioritizing merchants for display in any particular order. Table 11 illustrates conceptually a structure to record commissions for affiliate network sites, possibly include cost-per-action (CPA) and cost-per-click (CPC) commissions as described above. The values in the entries for Tables 10 and 11 are used only to conceptually illustrate parameters and are not necessarily indicative of the parameter values.

TABLE 10

| | | |
|---|---|---|
| Merchant | Rank | Commissions paid |
| Merchant 1 | Rank 1 | Amount 1 |
| Merchant 2 | Rank 2 | Amount 2 |
| Merchant N | Rank N | Amount N |

Table 11

| Affiliate Site | CPA Commissions | CPC Commissions |
|---|---|---|
| Affiliate site 1 | CPA amount 1 | CPC amount 1 |
| Affiliate site 2 | CPA amount 2 | CPC amount 2 |
| . . . | | |
| Affiliate site N | CPA amount N | CPC amount N |

The various calculations of rankings and commissions can be accomplished in step 168 as described above or as part of this separate method, or it may involve a combination of methods.

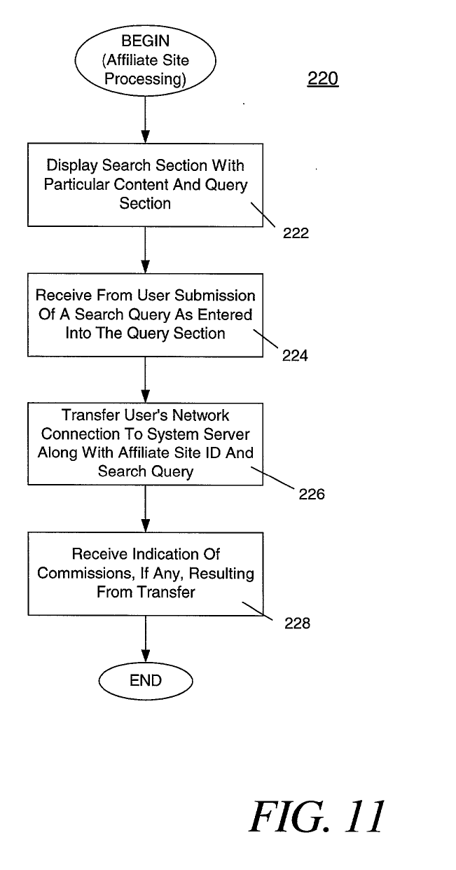

FIG. 11 is a flow chart of an affiliate site method 220 for use by affiliate site server 104 in processing information via search link 106. Method 220 can be implemented with, for example, software modules for execution by affiliate site server 104. In method 220, affiliate site server 104 displays, in screen 230 for example, search section 234 with particular content 236 and query section 238 for use in receiving a search query (step 222). The affiliate site server 104 receives from the user submission of a search query as entered into query section 238 (step 224). In response, it transfers the user's network connection to system server 102 along with the affiliate site ID and the search query (step 226). System server 102 then takes over processing of the user's session. Affiliate site server 104 may also receive at some point an indication of commissions, if any, resulting from transfer of the user's network connection along with the search query (step 228). Those commissions are described above and identified in, for example, Table 11.

While the present invention has been described in connection with an exemplary embodiment, it will be understood that many modifications will be readily apparent to those skilled in the art, and this application is intended to cover any adaptations or variations thereof. For example, various types of methodologies for payment of commissions for referrals, communication protocols, user interfaces, and linking for transferring users'network connections may be used without departing from the scope of the invention. This invention should be limited only by the claims and equivalents thereof.

What is claimed is:

1. A method for ranking and displaying search results, comprising:
receiving a search query;
performing a search, using the query, to identify merchants relating to the query;
obtaining results of the search including the identified merchants;
ranking the results based upon activity relating to the identified merchants; and
displaying the results based upon the ranking.

2. The method of claim 1 wherein the receiving step includes receiving the query transmitted from an affiliate network site.

3. The method of claim 2 wherein the receiving step includes receiving an identification of the affiliate network site with the query.

4. The method of claim 3, further including storing an indication of the affiliate network site associated with information relating to the query.

5. The method of claim 1 wherein the performing step includes searching one or more databases specifying identifications of selected merchants.

6. The method of claim 5 wherein the performing step includes identifying merchants offering goods or services relating to the search query.

7. The method of claim 1 wherein the ranking step includes determining for the merchants commissions paid based upon a cost-per-action ratio.

8. The method of claim 7 wherein the displaying step includes displaying identifications of the merchants in decreasing order of the commissions paid.

9. The method of claim 1 wherein the ranking step includes determining for the merchants commissions paid based upon a cost-per-click ratio.

10. The method of claim 5 wherein the ranking step includes determining which one of the databases was a source for the identified merchants and ranking the merchants based upon the determined source databases.

11. The method of claim 1 wherein the displaying step includes displaying an identification of the merchants linked with network addresses for the merchants.

12. The method of claim 1, further including:
receiving from a user selection of an identified merchant within the displayed results; and
transferring the user's network connection to the selected merchant's network site.

13. The method of claim 12, further including associating an identification of the selected merchant with the query and storing the identification and the associated query.

14. The method of claim 12, further including recording an indication of the selected merchant.

15. The method of claim 12, further including recording an indication of a purchase made through the selected merchant's network site.

16. The method of claim 5, further including retrieving information from the databases for use in performing the ranking.

17. The method of claim 2, further including recording an indication of a commission for the affiliate network site based upon a purchase made through the search.

18. The method of claim 17 wherein the recording step includes recording as the commission a percentage of an amount for the purchase.

19. The method of claim 18 wherein the recording step includes selecting a value of the percentage based upon the search query.

20. The method of claim 2, further including recording an indication of a commission for the affiliate network site based upon merchants accessed through the search.

21. The method of claim 20 wherein the recording step includes recording as the commission a percentage of revenue corresponding to the access and determining the percentage based upon another type of commission.

22. The method of claim 2, further including recording an indication of a commission for the affiliate network site based upon the search query.

23. The method of claim 2 wherein the receiving step includes receiving the query as entered into a search section on the affiliate network site, the search section having a particular content related to the affiliate network site.

24. A method for presenting a search section for use in searching and ranking merchants for display, comprising:
displaying on an affiliate network site a search section having content relating to the affiliate network site and a section for receiving a search query;
receiving from a user, via a network connection for the user, a submission of the search query entered into search section; and
transferring the user's network connection and search query to a system server that performs searches to identify merchants relating to the search query and displays results of the searches ranked based upon activity relating to the identified merchants.

25. The method of claim 24 wherein the transferring step includes transmitting to the system server an identification of the affiliate network site.

26. The method of claim 24 wherein the displaying step includes presenting within the search section text in a language relating to the affiliate network site.

27. The method of claim 24 wherein the displaying step includes selecting for presentation a search section among a plurality of configured search sections based upon particular criteria.

28. The method of claim 24 wherein the displaying step includes selecting a location for presentation of the search section within the affiliate network site based upon particular criteria.

29. The method of claim 24, further including receiving an indication of a commission for the affiliate network site based upon on-line activity relating to purchases made by the user associated with transferring the user's connection.

30. The method of claim 24, further including receiving an indication of a commission for the affiliate network site based upon on-line activity relating to merchants selected by the user associated with transferring the user's connection.

31. An apparatus for ranking and displaying search results, comprising:
a receive module for receiving a search query;
a perform module for performing a search, using the query, to identify merchants relating to the query;
a results module for obtaining results of the search including the identified merchants;
a ranking module for ranking the results based upon activity relating to the identified merchants; and
a display module for displaying the results based upon the ranking.

32. The apparatus of claim 31 wherein the receive module includes a module for receiving the query transmitted from an affiliate network site.

33. The apparatus of claim 32 wherein the receive module includes a module for receiving an identification of the affiliate network site with the query.

34. The apparatus of claim 33, further including a module for storing an indication of the affiliate network site associated with information relating to the query.

35. The apparatus of claim 31 wherein the perform module includes a module for searching one or more databases specifying identifications of selected merchants.

36. The apparatus of claim 35 wherein the perform module includes a module for identifying merchants offering goods or services relating to the search query.

37. The apparatus of claim 31 wherein the ranking module includes a module for determining commissions paid based upon a cost-per-action ratio.

38. The apparatus of claim 37 wherein the display module includes a module for displaying identifications of the merchants in decreasing order of the commissions paid.

39. The apparatus of claim 31 wherein the ranking module includes a module for determining commissions paid based upon a cost-per-click ratio.

40. The apparatus of claim 35 wherein the ranking module includes a module for determining which one of the databases was a source for the identified merchants and ranking the merchants based upon the determined source databases.

41. The apparatus of claim 31 wherein the display module includes a module for displaying an identification of the merchants linked with network addresses for the merchants.

42. The apparatus of claim 31, further including:
a module for receiving from a user selection of an identified merchant within the displayed results; and
a module for transferring the user's network connection to the selected merchant's network site.

43. The apparatus of claim 42, further including a module for associating an identification of the selected merchant with the query and storing the identification and the associated query.

44. The apparatus of claim 42, further including a module for recording an indication of the selected merchant.

45. The apparatus of claim 42, further including a module for recording an indication of a purchase made through the selected merchant's network site.

46. The apparatus of claim 45, further including a module for retrieving information from the databases for use in performing the ranking.

47. The apparatus of claim 42, further including a module for recording an indication of a commission for the affiliate network site based upon a purchase made through the search.

48. The apparatus of claim 47 wherein the recording module includes a module for recording as the commission a percentage of an amount for the purchase.

49. The apparatus of claim 48 wherein the recording module includes a module for selecting a value of the percentage based upon the search query.

50. The apparatus of claim 32, further including a module for recording an indication of a commission for the affiliate network site based upon merchants accessed through the search.

51. The apparatus of claim 50 wherein the recording module includes a module for recording as the commission a percentage of revenue corresponding to the access and determining the percentage based upon another type of commission.

52. The apparatus of claim 32, further including a module for recording an indication of a commission for the affiliate network site based upon the search query.

53. The apparatus of claim 32 wherein the receive module includes a module for receiving the query as entered into a search section on the affiliate network site, the search section having a particular content related to the affiliate network site.

54. An apparatus for presenting a search section for use in searching and ranking merchants for display, comprising:
a display module for displaying on an affiliate network site a search section having content relating to the affiliate network site and a section for receiving a search query;
a receive module for receiving from a user, via a network connection for the user, a submission of the search query entered into search section; and
a transfer module for transferring the user's network connection and search query to a system server that performs searches to identify merchants relating to the search query and displays results of the searches ranked based upon activity relating to the identified merchants.

55. The apparatus of claim 54 wherein the transfer module includes a module for transmitting to the system server an identification of the affiliate network site.

56. The apparatus of claim 54 wherein the display module includes a module for presenting within the search section text in a language relating to the affiliate network site.

57. The apparatus of claim 54 wherein the display module includes a module for selecting for presentation a search section among a plurality of configured search sections based upon particular criteria.

58. The apparatus of claim 54 wherein the display module includes a module for selecting a location for presentation of the search section within the affiliate network site based upon particular criteria.

59. The apparatus of claim 54, further including a module for receiving an indication of a commission for the affiliate network site based upon on-line activity relating to purchases made by the user associated with transferring the user's connection.

60. The apparatus of claim 54, further including a module for receiving an indication of a commission for the affiliate network site based upon on-line activity relating to merchants selected by the user associated with transferring the user's connection.

61. A screen for use in electronically displaying a search section for use in receiving a search query and linking with a system server that performs searches, comprising:
a screen representing an affiliate network site for display on a display device; and
a search section in the screen having content relating to the affiliate network site and having a section for receiving a search query from a user via a network connection,
wherein the search section includes an associated electronic link with a system server that performs searches to identify merchants relating to the search query and displays results of the searches ranked based upon activity relating to the identified merchants, and wherein electronic link is used to transfer the user's network connection and search query to the system server.

62. The screen of claim 61 wherein the search section includes text in a language relating to the affiliate network site.

63. The screen of claim 61 wherein the search section is presented within a location in the screen based upon particular criteria.

64. The screen of claim 61 wherein the electronic link includes an embedded network address for the system server.
